(19) United States
(12) Patent Application Publication
(10) Pub. No.: US 2026/0258243 A1
(43) Pub. Date: Sep. 3, 2026

(54) EPOXY RESIN COMPOSITIONCOMPOSITION COMPRISING THE SAME

(71) Applicant: KCC CORPORATION, Seoul (KR)

(72) Inventors: Pung Koc HWANG, Iksan-si, Jeonbuk-do (KR); Chan Young PARK, Wanju-gun, Jeonbuk-do (KR); Ji Seung PARK, Wanju-gun, Jeonbuk-do (KR); Eui Hyeon KIM, Wanju-gun, Jeonbuk-do (KR)

(21) Appl. No.: 19/474,185

(22) PCT Filed: Mar. 18, 2024
(86) PCT No.: PCT/KR2024/003346

§ 371 Date: Oct. 10, 2025

(30) Foreign Application Priority Data
Apr. 14, 2023 (KR) 10-2023-0049475

(51) Int. Cl. C08L 63/04

(52) U.S. Cl. CPC C08L 63/04; C08L 2207/53

(57) ABSTRACT

Provided herein is an epoxy resin composition for molding and a vehicle part molded using the same. According to an embodiment, an epoxy resin composition comprising an epoxy resin, a curing agent, a filler, and a core shell rubber (CSR) has a toughness of 25 to 100 kgf mm, a flexural strength of 9 to 17 kgf/mm2, and a flexural modulus of 1,500 to 2,400 kgf/mm2.

### TECHNICAL FIELD

The present invention relates to an epoxy resin composition and a vehicle part molded using the same.

### BACKGROUND ART

As the application fields of semiconductors have rapidly expanded, particularly in the automotive industry, the demand for semiconductor performance has increased, and accordingly, the level of reliability assessment required to meet this demand has also risen. In response to these industrial needs, the development of semiconductor component materials has also progressed in various ways. For example, Japanese Patent Publication No. 2017-197620 relates to an epoxy resin composition for sealing semiconductors, including an epoxy resin, a phenolic resin curing agent, and a filler, and discloses a technique for improving electrical connection reliability by adjusting the filler content and the thermal elastic modulus of the cured epoxy resin composition.

Epoxy resin compositions are excellent materials for encapsulating semiconductor devices due to their high mechanical strength, heat resistance, electrical insulation, and adhesion properties. However, due to differences in the coefficients of thermal expansion between the semiconductor material or device and the resin, curing shrinkage, or residual stress generated within the encapsulant under high-temperature conditions such as reflow, problems such as interfacial delamination at the interface with the substrate or the encapsulated device and cracking can arise.

Meanwhile, epoxy resin compositions may be used as molding materials for automotive parts, and for example, they may be utilized to fill or secure rotor core magnets. Such molding materials for automotive parts must withstand deformation and breakage caused by high-speed rotation during vehicle operation. When conventional thermosetting resins are used to secure rotor core magnets, the thermosetting resin may crack due to strong centrifugal forces during high-speed rotation of the rotor core (20,000 rpm or more), leading to the detachment of the magnet.

To address these issues, technologies applying various stress-relieving agents to epoxy resin compositions for molding are being developed. When carboxylic acid anhydride-based substances are applied as stress-relieving agents, they can impart low-stress characteristics to the composition, but they are difficult to disperse within the resin composition and have the drawback of deteriorating the moldability of the resin composition. Meanwhile, when other types of stress-relieving agents such as silicone oils are used, increasing their amounts may cause flow marks and similar defects on the surface of the molded material, adversely affecting its appearance and limiting the usable quantity. In the case of silicone resins, their stress-relieving effects are limited and they are expensive. Although silicone powders exhibit excellent stress-relieving effects, they reduce the strength of the resin composition, which can lead to breakage of the molded material.

Accordingly, there is a need to develop an epoxy resin composition for molding which exhibits excellent toughness and resists cracking, even under high-speed rotation.

### DISCLOSURE

### Technical Problem

The present invention provides an epoxy resin composition for molding which exhibits excellent toughness. The present invention also provides an automotive part molded using the epoxy resin composition for molding.

### Technical Solution

The present invention provides an epoxy resin composition including an epoxy resin, a curing agent, a filler, and a core shell rubber (CSR), which has a toughness of 25 to 100 kgf·mm, a flexural strength of 9 to 17 kgf/mm², and a flexural modulus of 1,500 to 2,400 kgf/mm².

### Advantageous Effects

The present invention provides an epoxy resin composition for molding which exhibits excellent toughness. The epoxy resin composition according to the present invention can be used as a molding material for automotive parts. In particular, the epoxy resin composition according to the present invention exhibits excellent toughness, making it suitable for use in applications such as filling or securing rotor core magnets.

### BEST MODE

Hereinafter, the present invention will be described in detail. However, the scope of the present invention is not limited by the description below, and each component may be variously modified or selectively combined as needed. Therefore, it should be understood that all modifications, equivalents, and substitutes falling within the spirit and technical scope of the present invention are included.

As used herein, “viscosity” is measured by conventional methods known in the art, for example, by using a Brookfield viscometer. Functional groups such as “hydroxyl group” are measured by conventional methods known in the art, for example, by titration. “Particle size (D50)” is measured by conventional methods known in the art, for example, by laser light scattering (LLS). “Glass transition temperature” is measured by conventional methods known in the art, for example, by thermomechanical analysis (TMA) or differential scanning calorimetry (DSC). “Softening point” is measured by conventional methods known in the art, for example, by using a dropping point system (DP70) from Mettler Toledo.

### <Epoxy Resin Composition>

The epoxy resin composition according to the present invention includes an epoxy resin, a curing agent, a filler, and a core shell rubber (CSR).

The toughness of the epoxy resin composition according to the present invention is 25 to 100 kgf·mm, for example, 40 to 80 kgf·mm, or 50 to 70 kgf·mm. For example, toughness may be measured according to ASTM D790 and defined as the area of the triangle formed by the maximum load (stress in kgf) and the maximum displacement (strain in mm) on the graph obtained during a three-point bending test. The maximum load is the load applied at the moment the specimen breaks during the three-point bending test, and the maximum displacement is the bending distance immediately before the specimen breaks during the test. When the toughness is below the above range, cracks may occur in the epoxy molding compound (EMC) due to strong centrifugal forces during high-speed rotation, which may result in detachment of the magnets when the composition is used to fill or secure rotor core magnets. To prepare an epoxy resin composition with toughness exceeding the above range, the type and amount of filler must be adjusted. However, using fibrous fillers such as glass fiber may reduce filling properties, adhesion, workability, etc.

The flexural strength of the epoxy resin composition according to the present invention is 9 to 17 kgf/mm², for example, 10 to 16 kgf/mm², or 11 to 15 kgf/mm². For example, flexural strength may be measured according to ASTM D790 and is defined as the force (maximum load) at the breaking point when a force is applied at the center point at a specified speed. When the flexural strength is below the above range, cracking may occur in the resin. To prepare an epoxy resin composition with flexural strength exceeding the above range, the type and amount of filler must be adjusted, and such adjustments may reduce flowability, filling properties, etc.

The flexural modulus of the epoxy resin composition according to the present invention is 1,500 to 2,400 kgf/mm², for example, 1,600 to 2,300 kgf/mm², or 1,650 to 2,000 kgf/mm². For example, flexural modulus may be measured according to ASTM D790 and may be defined as the slope of the graph of maximum load (stress in kgf) versus maximum displacement (strain in mm) obtained during a three-point bending test. When the flexural modulus is below the above range, ductility increases, which may cause workability issues after molding. When the flexural modulus exceeds the above range, brittleness increases, making the material more prone to fracture.

The glass transition temperature of the epoxy resin composition according to the present invention may be 150 to 250° C., for example, 170 to 220° C.

The epoxy resin composition of the present invention may be manufactured in powder form, granule form, or sheet form, depending on the intended application.

### Epoxy Resin

In the present invention, the epoxy resin is used as the main resin, and after reacting with a curing agent and curing, it forms a three-dimensional network structure that imparts strong and durable adhesion to a substrate as well as heat resistance.

Any epoxy resin commonly used in the relevant technical field may be used as the epoxy resin. For example, the epoxy resin may include two or more epoxy groups within its molecular structure. Non-limiting examples of usable epoxy resins include bisphenol A-type epoxy resin, cycloaliphatic epoxy resin, cresol novolac epoxy resin, dicyclopentadiene epoxy resin, biphenyl epoxy resin, naphthalene epoxy resin, anthracene epoxy resin, epoxy resins with non-condensed polycyclic structures, bisphenol fluorene-modified epoxy resin, and one or more thereof.

The epoxy resin may have an epoxy equivalent weight (EEW) of 50 to 350 g/eq, for example, 150 to 250 g/eq; a viscosity (at 150° C.) of 1 to 20 poise, for example, 2 to 10 poise; and a softening point of 60 to 80° C., for example, 65 to 70° C. Epoxy resins satisfying the above properties have relatively low viscosity, which enables flowability even when a high content of filler is included, and facilitates mixing. When the softening point of the epoxy resin exceeds the above range, the high viscosity may lead to poor flowability, resulting in underfilling and molding defects. When the softening point of the epoxy resin is below the above range, bleeding or flushing may occur, decreasing workability.

Based on the total weight of the epoxy resin composition, the content of the epoxy resin may be 5 to 30 wt %, for example, 10 to 20 wt %. When the epoxy resin content is below the above range, adhesion, flowability, and moldability may decrease. When the epoxy resin content exceeds the above range, increased moisture absorption may reduce the reliability of the molded material and a relative decrease in the filler content may reduce strength.

### Curing Agent

The epoxy resin composition of the present invention includes a curing agent. The curing agent serves to cure the composition by reacting with the epoxy resin.

Any curing agent that is known in the art to react with an epoxy resin may be used as the curing agent. For example, the curing agent may be a phenolic compound having two or more phenolic hydroxyl groups within a single molecule. For example, the curing agent may include one or more selected from the group consisting of phenol novolac resin, cresol novolac resin, phenol aralkyl resin, and polyfunctional phenolic compounds.

The curing agent may have a hydroxyl equivalent weight of 50 to 300 g/eq, for example, 80 to 150 g/eq; a viscosity (at 150° C.) of 0.1 to 30 poise, for example, 1 to 10 poise; an electrical conductivity of 15 μs/cm or less, for example, 9 μs/cm or less; a volatile content of 1% or less, for example, 0.2% or less; and a softening point of 70 to 90° C., for example, 75 to 88° C. When the hydroxyl equivalent weight of the curing agent exceeds the above range, the glass transition temperature may decrease. When the viscosity of the curing agent exceeds the above range, the hardness of the cured epoxy may decrease. In addition, when the electrical conductivity of the curing agent exceeds the above range, heat dissipation may decrease and voids may form. When the softening point of the curing agent exceeds the above range, rigidity may increase, leading to cracking.

Based on the total weight of the epoxy resin composition, the content of the curing agent may be 1 to 30 wt %, for example, 5 to 15 wt %. When the curing agent content is below the above range, curability and moldability may decrease. When the curing agent content exceeds the above range, increased moisture absorption may reduce the reliability of the molded material and decrease its strength.

### Filler

The epoxy resin composition of the present invention includes a filler. The filler serves to enhance the strength and flowability of the epoxy resin composition.

Any filler commonly used in the relevant technical field may be used as the filler without limitation. For example, inorganic fillers such as silica, silicon nitride, alumina, aluminum nitride, and boron nitride may be used alone or in combination of two or more. The shape of the filler is not particularly limited, and both angular and spherical forms may be used.

The filler may include two types of fillers with different particle sizes. For example, the filler may include a first filler having an average particle diameter (D50) of 3 to 14 μm, for example, 7 to 14 μm, and a second filler having an average particle diameter (D50) of 14.5 to 30 μm, for example, 14.5 to 21.5 μm.

Based on the total weight of the epoxy resin composition, the content of the filler may be 40 to 90 wt %, for example, 50 to 90 wt %. When the filler content is below the above range, the cured epoxy resin composition may absorb more moisture, thereby reducing the reliability of the molded material. When the filler content exceeds the above range, flowability may decrease, leading to reduced moldability.

### Core Shell Rubber (CSR)

The epoxy resin composition according to the present invention includes a core shell rubber (CSR). The CSR of the present invention serves as a stress-relieving agent and reduces the modulus while maintaining strength, thereby improving the toughness and flexural strength of the thermosetting resin and exhibiting excellent crack resistance.

The core may be a rubber-elastic material that is insoluble in the epoxy resin. Examples include butadiene-based materials such as polybutadiene, isoprene, and chloroprene; butadiene copolymers such as butadiene-styrene; (meth)acrylate types such as butyl (meth)acrylate, 2-ethylhexyl acrylate, and lauryl methacrylate; or silicone rubber, which may be used alone or in combination.

The shell serves to enhance compatibility between the epoxy resin and the core components, and may be formed as a structure that is grafted (bonded) to the core. To achieve stable dispersion within the epoxy resin composition, the shell may exhibit swelling, compatibility, or affinity with the epoxy resin. For example, the shell may be a (meth)acrylate-type polymer, such as polymethyl (meth)acrylate (PMMA), or acrylate copolymers with styrene, which may be used alone or in combination. The (co)polymer forming the shell may be surface-treated with organic or inorganic functional groups to enhance dispersibility. Examples of these organic or inorganic functional groups include, but are not limited to, organic groups such as hydroxyl, methyl, and ethyl groups, and inorganic groups such as silane groups.

For example, the core shell rubber (CSR) may include a core made of rubber-elastic materials such as silicone rubber, and a shell made of organic components such as polymethyl (meth)acrylate (PMMA). The shell has excellent compatibility, enhancing the affinity with the epoxy resin and the core components, and may be formed as a structure that is grafted (bonded) to the core, which also improves bonding with the resin and thereby enhances dispersion. The silicone rubber of the core imparts flexibility to the epoxy resin composition, lowering the modulus and thereby improving toughness.

The particle size (D50) of the CSR may be 45 μm or less, for example, 1 to 25 μm. When a CSR with a particle size (D50) in the above range is applied, dispersion is improved and the modulus of the epoxy resin composition is reduced, thereby enhancing toughness. When the particle size exceeds the above range, dispersion decreases, and concentrated stress in the regions where particles are aggregated may cause cracks or delamination. In addition, due to particle aggregation, the stress-relieving effect may not be fully realized, and mechanical properties such as strength may decrease.

The glass transition temperature of the CSR may be −200 to −50° C., for example, −140 to −120° C. When the glass transition temperature of the CSR is below the above range, the flexural strength of the epoxy resin composition may decrease, and when the glass transition temperature exceeds the above range, the flexural modulus may decrease. As a result, the toughness of the epoxy resin composition is reduced, which may cause cracks in the epoxy molding compound (EMC). When it is used for filling or securing rotor core magnets, magnet detachment may occur.

Based on the total weight of the epoxy resin composition, the CSR content may be 0.01 to 10 wt %, for example, 1 to 5 wt %. When the CSR content is below the above range, the stress-relieving effect and toughness enhancement effect may not be sufficiently realized. When the CSR content exceeds the above range, mechanical properties such as strength may decrease, and thermal properties such as glass transition temperature and coefficient of thermal expansion may deteriorate.

### Additives

The epoxy resin composition according to the present invention may further include additives commonly used in the relevant technical field, such as adhesion promoters, release agents, catalysts, coloring agents, and flame retardants.

As adhesion promoters for enhancing bonding with organic/inorganic interfaces and metal substrates, epoxy silanes, amino silanes, mercapto silanes, acrylic silanes, vinyl silanes, etc. may be used. As release agents for improving the release properties between the epoxy molding compound (EMC) and external molds, long-chain fatty acids, metal salts of long-chain fatty acids, paraffin wax, carnauba wax, polyethylene wax, etc. may be used. In addition, as curing accelerators to increase curing speed and workability, imidazole compounds, amine compounds, organic phosphine compounds, etc. may be used. Additionally, the composition may further include additives such as coloring agents (e.g., carbon black, bengala) for imparting color to the resin composition, and flame retardants (e.g., metal hydroxides).

These additives may be included within known content ranges in the relevant technical field. For example, they may be included in amounts of 0.01 to 10 wt % each based on the total weight of the epoxy resin composition, but are not limited thereto.

### <Semiconductor Devices and Vehicle Parts>

The present invention provides an automotive part molded using the above-described epoxy resin composition. For example, the epoxy resin composition described above may be used as a molding material to fix and seal components within vehicle parts that require excellent vibration resistance, heat resistance, dimensional stability, and deformation resistance.

For example, a permanent magnet may be inserted into a void formed inside a rotor core, and the epoxy resin composition of the present invention may be filled between the void and the permanent magnet to fix the permanent magnet within the rotor core.

Hereinafter, the present invention will be described in more detail through examples. However, the following examples are provided only to facilitate understanding of the present invention and are not intended to limit the scope of the present invention to these examples.

### Experimental Examples 1-9

An epoxy resin composition for each experimental example was prepared by mixing the components according to the composition shown in Table 1 below. The properties of each resin composition were measured using the following method, and the results are shown in Table 1 below.

### Specimen Preparation

The kneaded product of the epoxy resin composition prepared in each experimental example was molded by transfer molding at 175° C. for 120 seconds to prepare a specimen for property evaluation.

### Toughness

Toughness was measured according to ASTM D790. Four specimens, each with dimensions of 125 mm×12.5 mm×6 mm (thickness), were prepared. Toughness was evaluated by calculating the area of the triangle formed by the maximum load (stress in kgf) and the maximum displacement (strain in mm) on the graph obtained during a three-point bending test using a universal testing machine (UTM) (support span distance: 100 mm, crosshead speed: 2.8 mm/min). The maximum load is defined as the load applied at the moment the specimen breaks during the three-point bending test, and the maximum displacement is the bending distance immediately before the specimen breaks during the test.

### Flexural Strength

Flexural strength was evaluated according to ASTM D790 by measuring the load at the breaking point (maximum load) when a force was applied at a specified speed to the center point of the specimen.

### Flexural Modulus

Flexural modulus was evaluated according to ASTM D790 by determining the slope of the graph of maximum load (stress in kgf) versus maximum displacement (strain in mm) obtained during a three-point bending test.

TABLE 1

| | Experimental Example | | | | | | | | |
|---|---|---|---|---|---|---|---|---|---|
| Component (wt %) | 1 | 2 | 3 | 4 | 5 | 6 | 7 | 8 | 9 |
| Epoxy resin | 16.9 | 16.9 | 16.9 | 16.9 | 16.9 | 16.9 | 16.9 | 16.9 | 16.9 |
| Curing agent | 8.7 | 8.7 | 8.7 | 8.7 | 8.7 | 8.7 | 8.7 | 8.7 | 8.7 |
| Filler | 70 | 68 | 68 | 70.5 | 64 | 68 | 68 | 68 | 71 |
| CSR-A | 1 | 3 | 3 | 0.5 | 7 | | | | |
| CSR-B | | | | | | 3 | | | |
| CSR-C | | | | | | | 3 | | |
| Silicone powder | | | | | | | | 3 | |
| Silane | 0.4 | 0.4 | 0.4 | 0.4 | 0.4 | 0.4 | 0.4 | 0.4 | 0.4 |
| Wax | 0.4 | 0.4 | 0.4 | 0.4 | 0.4 | 0.4 | 0.4 | 0.4 | 0.4 |
| Coloring agent | 0.2 | 0.2 | 0.2 | 0.2 | 0.2 | 0.2 | 0.2 | 0.2 | 0.2 |
| Catalyst | 0.3 | 0.3 | 0.3 | 0.3 | 0.3 | 0.3 | 0.3 | 0.3 | 0.3 |
| Flame retardant | 2.1 | 2.1 | 2.1 | 2.1 | 2.1 | 2.1 | 2.1 | 2.1 | 2.1 |
| Total | 100 | 100 | 100 | 100 | 100 | 100 | 100 | 100 | 100 |
| Toughness (kgf · mm) | 62.4 | 78.5 | 78.5 | 25.1 | 61.5 | 23.8 | 22.2 | 21.1 | 21.1 |
| Flexural strength (kgf/mm²) | 13 | 12.9 | 12.9 | 13 | 12.1 | 8.9 | 8.8 | 8.5 | 8.1 |
| Flexural modulus (kgf/mm²) | 1850 | 1660 | 1660 | 2558 | 1310 | 1510 | 1560 | 1515 | 2515 |

Epoxy resin: O-cresol novolac type, epoxy equivalent weight of 200 g/eq, viscosity (150° C.) of 7 poise, softening point of 67° C.

Curing agent: Phenol resin, hydroxyl equivalent weight of 120 g/eq, viscosity (150° C.) of 6 poise, electrical conductivity of 5 μs/cm, volatile content of 0.1%, softening point of 83° C.

Filler: Mixture of spherical and angular silica with an average particle size (D50) of 19.9 μm

CSR-A: Silicone core, polymethyl(meth)acrylate (PMMA) shell, particle size (D50) of 10 μm, glass transition temperature (Tg) of −130° C.

CSR-B: Silicone core, PMMA shell, particle size (D50) of 20 μm, Tg of −45° C.

CSR-C: Silicone core, PMMA shell, particle size (D50) of 50 μm, Tg of −65° C.

Silicone powder: Particle size (D50) of 5 μm

Silane: Epoxy silane (boiling point of 190° C.)

Wax: Polyethylene wax (acid value of 15-30 mg KOH/g)

Coloring agent: Carbon black with an average particle size of 20 nm

Catalyst: Imidazole-based (2MZ, SHIKOKU CHEMICALS CORPORATION)

Flame retardant: Inorganic magnesium-based flame retardant

### [Property Evaluation]

The properties of the epoxy resin composition prepared in each experimental example were measured as follows, and the results are shown in Table 2 below.

### Flowability (Spiral Flow)

Flowability was measured using an evaluation mold according to EMMI-1-66 with a transfer molding press (at 175° C. and 70 kgf/cm²). It is preferable to secure a flowability of 30 inches or more to ensure that the epoxy molding compound (EMC) flows to and fills the slot area where the magnet is inserted within the rotor core.

### G/T

Using a hot plate set to the same temperature as the mold press (175° C.), the time from the point each specimen begins to melt to the gelation point was measured. To ensure that the epoxy molding compound (EMC) adequately fills the slot area, it is preferable to have a gel time of 15 seconds or more.

### Glass Transition Temperature/Coefficient of Linear Expansion

Specimens of the same size were molded and measured from room temperature to 300° C. at a heating rate of 10° C./min using a thermo-mechanical analyzer (TMA). The glass transition temperature was determined by the onset point method. Considering the heat generated by the high-speed rotation of the rotor core, it is preferable to secure a glass transition temperature of 170° C. or higher to minimize shrinkage/expansion during heating and cooling processes and to prevent cracking of the epoxy molding compound (EMC).

In addition, the coefficients of linear expansion below and above the glass transition temperature, a1 and a2 respectively, were measured using the thermo-mechanical analyzer (TMA). When a1 is 20 ppm/° C. or less and a2 is 80 ppm/° C. or less, delamination and cracking caused by shrinkage and expansion may be effectively prevented.

### Ag Delamination

TO-247 packages were molded using a multi-gang pot (MGP) system with a general-purpose lead frame plated with silver (Ag). The molded packages were then post-cured and subjected to five cycles of a 260° C. IR reflow process. Internal delamination was subsequently examined using scanning acoustic tomography (SAT) and evaluated as Excellent (⊚), Good (∘), Fair (Δ), or Poor (X).

### Magnet Detachment Force/Crack

The magnet slots of rotor cores were molded using the epoxy resin composition of each experimental example, and the maximum load (kgf) required to detach the magnets from the slots was measured using a universal testing machine (UTM). A maximum load of 50 kgf or more was considered a pass. The molded EMC areas were also inspected for underfilling and crack, which were evaluated as Excellent (⊚), Good (∘), Fair (Δ), or Poor (X). PG-2T

TABLE 2

| | Experimental Example | | | | | | | | |
|---|---|---|---|---|---|---|---|---|---|
| Items | 1 | 2 | 3 | 4 | 5 | 6 | 7 | 8 | 9 |
| S/F (inch) | 39 | 40 | 40 | 40 | 38 | 32 | 34 | 31 | 30 |
| G/T (sec) | 25 | 23 | 23 | 24 | 24 | 22 | 23 | 24 | 24 |
| Tg | 185 | 186 | 186 | 186 | 185 | 175 | 174 | 170 | 170 |
| a1 | 17 | 17.1 | 17.4 | 17.2 | 17.5 | 17.4 | 17.7 | 17.3 | 17.4 |
| a2 | 71.2 | 70.9 | 70.9 | 70.5 | 71.1 | 71.1 | 72.1 | 71.5 | 71.8 |
| Delamination | ⊚ | ⊚ | ⊚ | ◯ | ◯ | Δ | ◯ | ◯ | X |
| Magnet detachment force | 78 | 76 | 77 | 58 | 59 | 54 | 54 | 53 | 50 |
| Crack | ⊚ | ⊚ | ⊚ | ◯ | ◯ | ◯ | Δ | ◯ | X |

As shown in Table 2, the epoxy resin compositions of Experimental Examples 1 to 3 according to the present invention exhibited excellent properties across all measured items. In contrast, the epoxy resin compositions of Experimental Examples 4 and 5, whose flexural modulus falls outside the range of the present invention, and Experimental Examples 6 and 7, whose toughness and flexural strength fall outside the range of the present invention, showed generally inferior properties compared to Experimental Examples 1 to 3. In addition, when using the epoxy resin composition of Experimental Example 8, which includes silicone powder instead of the core shell rubber, and Experimental Example 9, which does not include core shell rubber, the magnets easily detached from the slots. In particular, the epoxy resin composition of Experimental Example 9 showed delamination of the Ag plating and crack in the EMC area.

### INDUSTRIAL APPLICABILITY

The present invention provides an epoxy resin composition for molding which exhibits excellent toughness, and a vehicle part molded using the epoxy resin composition for molding.

1. An epoxy resin composition comprising an epoxy resin, a curing agent, a filler, and a core shell rubber (CSR),
wherein the epoxy resin composition has a toughness of 25 to 100 kgf·mm, a flexural strength of 9 to 17 kgf/mm², and a flexural modulus of 1,500 to 2,400 kgf/mm².

2. The epoxy resin composition of claim 1, wherein the epoxy resin has an epoxy equivalent weight (EEW) of 50 to 350 g/eq, a viscosity (at 150° C.) of 1 to 20 poise, and a softening point of 60 to 80° C.

3. The epoxy resin composition of claim 1, wherein the curing agent has a hydroxyl equivalent weight of 50 to 300 g/eq, a viscosity (at 150° C.) of 0.1 to 30 poise, an electrical conductivity of 15 μs/cm or less, a volatile content of 1% or less, and a softening point of 70 to 90° C.

4. The epoxy resin composition of claim 1, wherein the core of the core shell rubber (CSR) includes one or more selected from the group consisting of butadienes, butadiene copolymers, (meth)acrylates, and silicone rubber, and
the shell of the core shell rubber (CSR) includes one or more selected from the group consisting of (meth)acrylate polymers and styrene-acrylate copolymers.

5. The epoxy resin composition of claim 1, wherein the core shell rubber (CSR) has a particle size (D50) of 45 μm or less and a glass transition temperature of −200 to −50° C.

6. The epoxy resin composition of claim 1, wherein based on the total weight of the epoxy resin composition, 5 to 30 wt % of the epoxy resin, 1 to 30 wt % of the curing agent, 40 to 90 wt % of the filler, and 0.01 to 10 wt % of the core shell rubber (CSR) are included.

7. A vehicle part molded using the epoxy resin composition according to claim 1.
